(19) United States
(12) Patent Application Publication
(10) Pub. No.: US 2008/0100778 A1
(43) Pub. Date: May 1, 2008

(54) Liquid crystal display having optical concentrating layer

(75) Inventors: Kai Meng, Shenzhen (CN); Fei Yin, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO.,; INNOLUX DISPLAY CORP.

(21) Appl. No.: 11/978,278

(22) Filed: Oct. 29, 2007

(30) Foreign Application Priority Data
Oct. 27, 2006 (TW) 95139812

(51) Int. Cl. G02F 1/1335

(52) U.S. Cl. 349/95

(57) ABSTRACT

An exemplary liquid crystal display (2) includes a first substrate (200), a second substrate (210), a liquid crystal layer (220) interposed between the two substrates, a color filter layer (240) disposed between the two substrates, and an optical concentrating layer (260) provided between the two substrates. The liquid crystal display has high light utilization efficiency.

### FIELD OF THE INVENTION

The present invention relates to liquid crystal displays, and particularly to a liquid crystal display having an optical concentrating layer.

### GENERAL BACKGROUND

Conventionally, there have been three types of LCD devices commercially available: a reflection type LCD device utilizing ambient light, a transmission type LCD device utilizing backlight, and a semi-transmission type LCD device equipped with a half mirror and a backlight.

Referring to FIG. 7, a typical transflective liquid crystal display 1 includes a liquid crystal panel 10, and a backlight module 11 for providing light beams to the liquid crystal panel 10. The liquid crystal panel 10 includes a first substrate 100, a second substrate 110, and a liquid crystal layer 120. The first substrate 100 is parallel to the second substrate 110. The liquid crystal layer 120 is interposed between the first substrate 100 and the second substrate 110.

A first polarizer 130 is disposed on an outer surface of the first substrate 100. A color filter layer 140, a planarization layer 170, and a common electrode 180 are disposed on an inner surface of the first substrate 100, in that order from the first substrate 100 to the liquid crystal layer 120.

The color filter layer 140 includes a plurality of red filter units 141, a plurality of green filter units 142, and a plurality of blue filter units 143. The red filter units 141, the green filter units 142, and the blue filter units 143 are arranged in a matrix, and are separated from one another by a black matrix 150. The planarization layer 170 is used to protect the color filter layer 140 and the black matrix 150.

A second polarizer 112 is disposed on an outer surface of the second substrate 110. A transflective film 111 is disposed on the second polarizer 112. A pixel electrode layer 114 is disposed on an inner surface of the second substrate 110. The transflective film 111 is used to reflect ambient light beams, and transmit light beams from the backlight module 11.

In an environment of strong ambient light beams, the liquid crystal display 1 can display images solely by utilizing the ambient light beams. When the incident ambient light beams transmit perpendicularly into the liquid crystal panel 10, the reflective ambient light beams return along the same paths as the incident light beams. For example, if the incident ambient light beams transmit through a red filter unit 141, the reflective ambient light beams emit through the same red filter unit 141. However, when the incident ambient light beams transmit into the liquid crystal panel 10 at oblique angles, the reflective ambient light beams return back along different paths according to the basic reflection principle. That is, if the incident ambient light beams transmit through a red filter unit 141, the reflective ambient light beams may transmit through a red filter unit 141, a green filter unit 142 or a blue filter unit 143.

For example, when incident ambient light beams transmit through a red filter unit 141 and the reflective ambient light beams transmit through a red filter unit 141, the reflective ambient light beams can pass through the red filter unit 141. However, if the reflective ambient light beams transmit through a green filter unit 142 or a blue filter unit 143, the red reflective ambient light beams are absorbed by the green filter unit 142 or the blue filter unit 143. Thus overall, much of the reflective ambient light beams of all three primary colors are lost, and the light utilization efficiency of the ambient light beams is low.

What is needed, therefore, is a liquid crystal display that can overcome the above-described deficiencies.

### SUMMARY

In one preferred embodiment, a liquid crystal display includes a first substrate, a second substrate, a liquid crystal layer interposed between the two substrates, a color filter layer disposed between the two substrates, and an optical concentrating layer provided between the two substrates.

Other novel features and advantages of the present liquid crystal display will become more apparent from the following detailed description when taken in conjunction with the accompanying drawings. In the drawings, all the views are schematic.

### BRIEF DESCRIPTION OF THE DRAWINGS

FIG. 1 is a side, cross-sectional view of a liquid crystal display according to a first embodiment of the present invention, the liquid crystal display including a liquid crystal panel, the liquid crystal panel including a color filter layer and an optical concentrating layer.

FIG. 2 is a bottom plan view of the optical concentrating layer and the color filter layer of the liquid crystal panel of FIG. 1.

FIG. 3 is an enlarged view of part of the liquid crystal panel of FIG. 1, showing essential optical paths thereof.

FIG. 4 is a schematic, side view of a liquid crystal display according to a second embodiment of the present invention, the liquid crystal display including a liquid crystal panel, the liquid crystal panel including a color filter layer and an optical concentrating layer.

FIG. 5 is a bottom plan view of the optical concentrating layer and the color filter layer of the liquid crystal panel of FIG. 4.

FIG. 6 is a side, cross-sectional view of a liquid crystal display according to a third embodiment of the present invention.

FIG. 7 is a side, cross-sectional view of a conventional liquid crystal display.

### DETAILED DESCRIPTION OF PREFERRED EMBODIMENTS

Reference now is made to the drawing figures to describe various embodiments of the present invention in detail.

Referring to FIG. 1, a liquid crystal display 2 according to a first embodiment of the present invention is shown. The liquid crystal display 2 includes a transflective liquid crystal panel 20, and a backlight module 21 for providing light beams to the liquid crystal panel 20. The liquid crystal panel 20 includes a first substrate 200, a second substrate 210, and a liquid crystal layer 220. The first substrate 200 is parallel to the second substrate 210. The liquid crystal layer 220 is interposed between the first substrate 200 and the second substrate 210.

A first polarizer 230 is disposed on an outer surface of the first substrate 200. A color filter layer 240, an optical concentrating layer 260, a planarization layer 270, and a common electrode 280 are disposed on an inner surface of the first substrate 200, in that order from the first substrate 200 to the liquid crystal layer 220. The planarization layer 270 is used to protect the color filter layer 240. The planarization layer 270 is made from phototonus material.

The color filter layer 240 includes a plurality of red filter units 241, a plurality of green filter units 242, and a plurality of blue filter units 243. The red filter units 241, the green filter units 242, and the blue filter units 243 are arranged in a matrix, and are separated from one another by a black matrix 250.

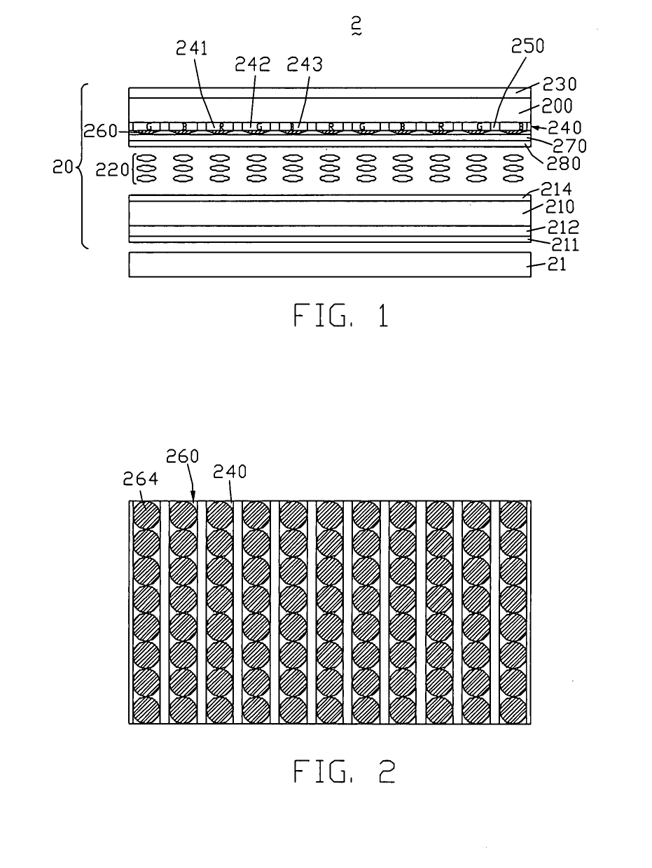

Referring also to FIG. 2, the optical concentrating layer 260 includes a plurality of optical concentrating members 264. Each of the red filter units 241, the green filter units 242, and the blue filter units 243 corresponds to one respective optical concentrating member 264. Each of the optical concentrating members 264 is in the shape of a microconvexity (or microdome). A distance between the transflective film 211 and the optical concentrating layer 260 is less than a focal length of the microconvexity of each optical concentrating member 264 of the optical concentrating layer 260. A refractive index of the microconvexity of each optical concentrating member 264 is greater than that of the planarization layer 270.

A second polarizer 212 is disposed on an outer surface of the second substrate 210. A transflective film 211 is disposed on the second polarizer 212. A pixel electrode layer 214 is disposed on an inner surface of the second substrate 210. The transflective film 211 can reflect ambient light beams, and transmit light beams emitted from the backlight module 21.

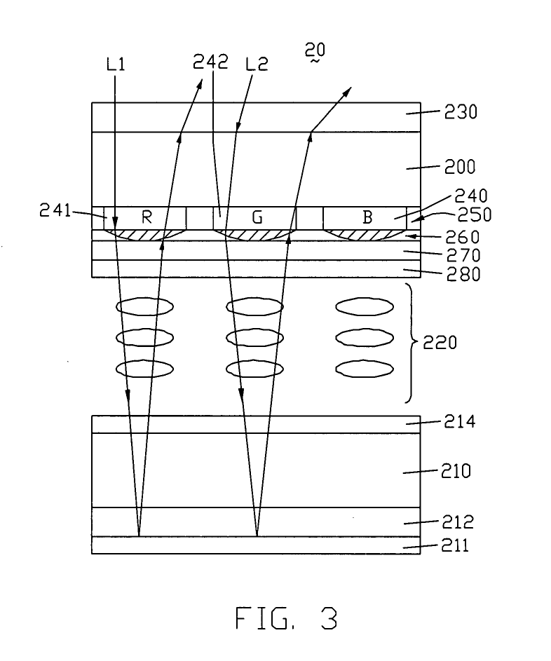

Referring to FIG. 3, this shows optical paths of ambient light beams in the liquid crystal panel 20. If an incident ambient light beam L1 transmits perpendicularly through a red filter unit 241 of the color filter layer 240, the reflected ambient light beam transmits through the same red filter unit 241. If an incident ambient light beam L2 transmits through the green filter unit 242 of the color filter layer 240 with an oblique incident angle, the light beam L2 is refracted by the corresponding optical concentrating member 264 to be a more collimated light beam transmitting through a predetermined area corresponding to the green filter unit 242. The collimated light beam is reflected by the transflective film 211 and returns back up. Because the distance between the transflective film 211 and the optical concentrating layer 260 is less than a focal length of the microconvexity of the optical concentrating member 264, the reflective light beam is apt to transmit through the same green filter unit 242. Therefore compared to a conventional liquid crystal display, the liquid crystal display 2 has less loss of ambient light beams. That is, the liquid crystal display 2 has high light utilization efficiency.

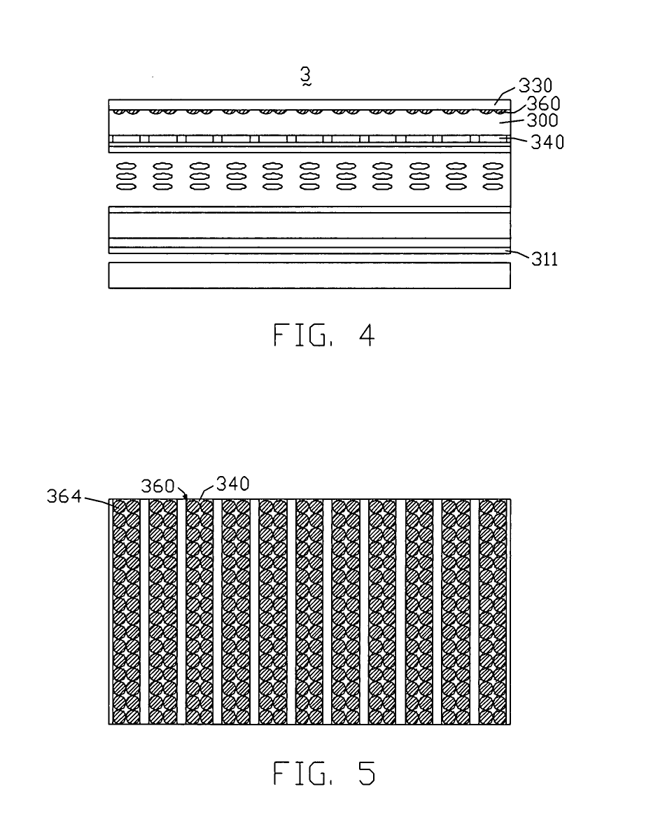

Referring to FIG. 4, a liquid crystal display 3 according to a second embodiment of the present invention is shown. The liquid crystal display 3 is similar to the liquid crystal display 2. However, an optical concentrating layer 360 is disposed between a first substrate 300 and a first polarizer 330. Referring also to FIG. 5, a focal length of each of a plurality of optical concentrating members 364 of the optical concentrating layer 360 is greater than a distance between the optical concentrating layer 360 and a transflective film 311. Each of a plurality of red filter units, a plurality of green filter units 242, and a plurality of blue filter units of a color filter layer 340 corresponds to two respective optical concentrating members 364. The liquid crystal display 3 can achieve advantages similar to those of the liquid crystal display 2.

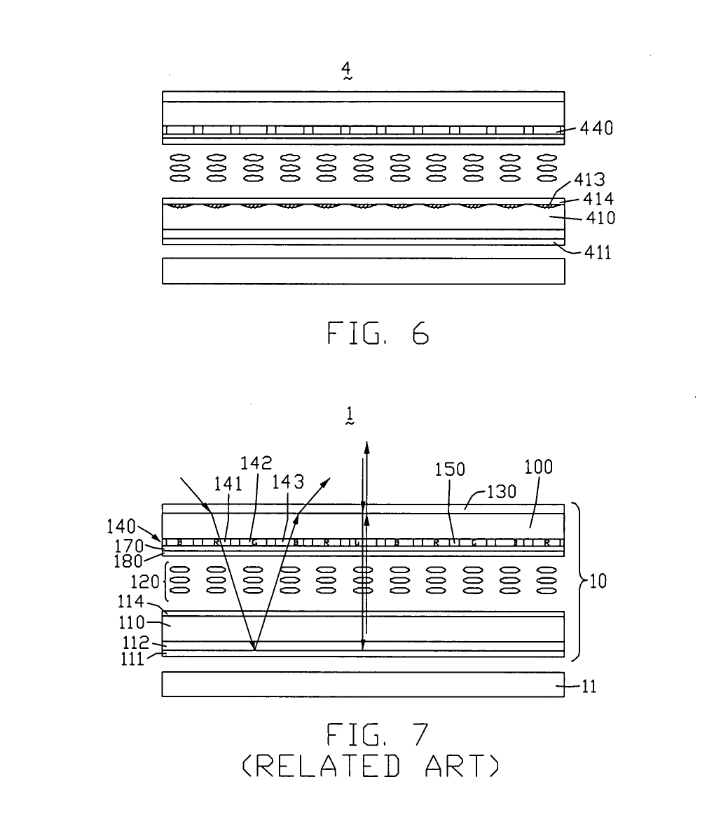

Referring to FIG. 6, a liquid crystal display 4 according to a third embodiment of the present invention is shown. The liquid crystal display 4 is similar to the liquid crystal display 2. However, an optical concentrating layer 413 is disposed between a second substrate 410 and a pixel electrode layer 414, and corresponds to a color filter layer 440. A distance between the optical concentrating layer 413 and a transflective layer 411 is less than a focal length of each of a plurality of optical concentrating members (not labeled) of the optical concentrating layer 413. The liquid crystal display 4 can achieve advantages similar to those of the liquid crystal display 2.

In further and/or alternative embodiments, a transflective film can be disposed on an inner surface or an outer surface of the first substrate of the transflective liquid crystal display. A color filter can instead be disposed on the second substrate. In addition, an optical concentrating layer can be employed in other types of transflective liquid crystal displays such as a transflective liquid crystal display whose pixel electrode layer includes reflective areas. Furthermore, an optical concentrating layer can be employed in a reflection type liquid crystal display. For example, the transflective film of any of the above-described transflective liquid crystal displays 2, 3, 4 can be replaced by a reflective film. Moreover, a first polarizer and/or a second polarizer can be disposed on an inner surface of the first substrate and/or the second substrate.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display comprising:
a first substrate;
a second substrate;
a liquid crystal layer interposed between the two substrates;
a color filter layer disposed between the first substrate and the second substrate; and
an optical concentrating layer provided between the first substrate and the second substrate.

2. The liquid crystal display as claimed in claim 1, wherein the color filter layer comprises a plurality of red filter units, a plurality of green filter units, and a plurality of blue filter units.

3. The liquid crystal display as claimed in claim 2, wherein the optical concentrating layer comprises a plurality of optical concentrating members, one color filter unit corresponding to at least one optical concentrating member.

4. The liquid crystal display as claimed in claim 3, wherein the optical concentrating members are in the shape of microconvexities.

5. The liquid crystal display as claimed in claim 4, wherein the optical concentrating layer is disposed on the color filter layer adjacent the liquid crystal layer.

6. The liquid crystal display as claimed in claim 5, wherein the liquid crystal display is a transflective display.

7. The liquid crystal display as claimed in claim 6, further comprising a transflective film disposed on the second substrate.

8. The liquid crystal display as claimed in claim 7, wherein a focal length of each of the microconvexities is greater than a distance between the microconvexity and the transflective film.

9. The liquid crystal display as claimed in claim 4, wherein the optical concentrating layer is disposed on a surface of the first substrate farthest from the liquid crystal layer.

10. The liquid crystal display as claimed in claim 4, wherein the optical concentrating layer is disposed on a surface of the second substrate adjacent the liquid crystal layer.

11. The liquid crystal display as claimed in claim 4, wherein the optical concentrating layer is disposed on a surface of the second substrate farthest from the liquid crystal layer.

12. The liquid crystal display as claimed in claim 1, further comprising a first polarizer disposed on a surface of the first substrate and a second polarizer disposed on a surface of the second substrate.

13. The liquid crystal display as claimed in claim 1, wherein the liquid crystal display is a reflective display.

14. The liquid crystal display as claimed in claim 13, further comprising a reflective film disposed on the second substrate.

15. A liquid crystal display comprising:
a first substrate;
a second substrate;
a liquid crystal layer interposed between the two substrates;
a color filter layer disposed on between the two substrates, the color filter layer including a plurality of red filter units, a plurality of green filter units, and a plurality of blue filter units;
a pixel electrode layer disposed on a surface of the second substrate adjacent the liquid crystal layer;
a first polarizer disposed on a surface of the first substrate farthest from the liquid crystal layer;
a second polarizer disposed on a surface of the second substrate farthest from the liquid crystal layer;
a reflective film disposed at the second substrate; and
an optical concentrating layer disposed between the first polarizer and the second polarizer, the optical concentrating layer configured to at least partly collimate incoming ambient light beams that respectively transmit through each of the red filter units, each of the green filter units, and each of the blue filter units such that at least most of the ambient light beams that transmit through any one of the red, green, and blue filter units are reflected by the reflective film and transmit back through the same red, green, or blue filter unit.

16. The liquid crystal display as claimed in claim 15, wherein the optical concentrating layer comprises a plurality of optical concentrating members.

17. The liquid crystal display as claimed in claim 16, wherein the optical concentrating members are in shape of microconvexities.

18. The liquid crystal display as claimed in claim 16, wherein the optical concentrating layer is disposed between the first substrate and the first polarizer.

19. The liquid crystal display as claimed in claim 16, wherein the optical concentrating layer is disposed on a surface of the second substrate adjacent the liquid crystal layer.

20. The liquid crystal display as claimed in claim 16, wherein the optical concentrating layer is disposed between the second substrate and the second polarizer.
